(19) United States
(12) Patent Application Publication
(10) Pub. No.: US 2025/0372932 A1
(43) Pub. Date: Dec. 4, 2025

(54) TERMINAL BLOCK AND METHOD FOR MANUFACTURING TERMINAL BLOCK

(71) Applicant: Yazaki Corporation, Tokyo (JP)

(72) Inventors: Yasuhiro TANAKA, Shizuoka (JP); Yasuhiro OTSUTA, Shizuoka (JP); Masatoshi YAMADA, Shizuoka (JP); Shogo FURUI, Shizuoka (JP); Junya YAMAMOTO, Shizuoka (JP)

(73) Assignee: Yazaki Corporation, Tokyo (JP)

(21) Appl. No.: 19/199,718

(22) Filed: May 6, 2025

(30) Foreign Application Priority Data
May 28, 2024 (JP) 2024-086091

(51) Int. Cl. H01R 43/00; H01R 9/24

(52) U.S. Cl. CPC H01R 43/005; H01R 9/24

(57) ABSTRACT

A terminal block includes a bus bar, a housing provided with an insertion space portion into which a second connection portion of the bus bar is inserted along an axial direction, a packing inserted into the insertion space portion together with the second connection portion and sealing an annular space between an outer surface of the second connection portion and an inner surface of the insertion space portion, and a packing holder provided with a bus bar insertion portion into which the second connection portion is inserted along the axial direction, and is inserted into the insertion space portion in a state where the second connection portion is inserted into the bus bar insertion portion and the other end face in the axial direction is in contact with the packing and one end face in the axial direction is in contact with a planar portion.

### CROSS-REFERENCE TO RELATED APPLICATION(S)

The present application claims priority to and incorporates by reference the entire contents of Japanese Patent Application No. 2024-086091 filed in Japan on May 28, 2024.

### BACKGROUND OF THE INVENTION

### 1. Field of the Invention

The present invention relates to a terminal block and a method for manufacturing a terminal block.

### 2. Description of the Related Art

As a technique related to a terminal block in the related art, for example, JP 2010-211 933 A discloses a terminal block including a bus bar provided with a first connection portion and a second connection portion, a housing provided with an insertion space portion into which the second connection portion of the bus bar is inserted, a packing inserted into the insertion space portion together with the second connection portion of the bus bar and sealing an annular space between an outer surface of the second connection portion and an inner surface of the insertion space portion, and a packing holder provided with a bus bar insertion portion into which the second connection portion is inserted along an axial direction and inserted into the insertion space portion in a state where the second connection portion is inserted into the bus bar insertion portion and the other end face in the axial direction is in contact with the packing.

Here, in the terminal block disclosed in JP 2010-211 933 A described above, for example, there is room for further improvement in terms of improving the assemblability of the bus bar, the packing, and the packing holder with respect to the housing.

### SUMMARY OF THE INVENTION

The present invention has been made in view of the above circumstances, and an object of the present invention is to provide a terminal block and a method for manufacturing a terminal block capable of improving assemblability to a housing.

In order to achieve the above mentioned object, a terminal block according to one aspect of the present invention includes a bus bar including a first connection portion extending along an axial direction and connected to a first connection terminal, a second connection portion extending along the axial direction and positioned to be shifted in a plate thickness direction intersecting the axial direction and the axial direction with respect to the first connection portion and connected to a second connection terminal, and an intermediate portion connected between the first connection portion and the second connection portion and including a planar portion extending along the plate thickness direction; a housing provided with an insertion space portion into which the second connection portion of the bus bar is inserted along the axial direction; a packing that is inserted into the insertion space portion together with the second connection portion and seals an annular space between an outer surface of the second connection portion and an inner surface of the insertion space portion; and a packing holder provided with a bus bar insertion portion through which the second connection portion is inserted along the axial direction, the packing holder being inserted into the insertion space portion in a state where the second connection portion is inserted into the bus bar insertion portion, and the other end face in the axial direction is in contact with the packing and one end face in the axial direction is in contact with the planar portion.

In order to achieve the above mentioned object, a method for manufacturing a terminal block according to another aspect of the present invention includes a first step of assembling a packing holder including a bus bar insertion portion into which a second connection portion is inserted along an axial direction, with respect to a bus bar including a first connection portion extending along the axial direction and connected to a first connection terminal, the second connection portion extending along the axial direction and positioned to be shifted in a plate thickness direction intersecting the axial direction and the axial direction with respect to the first connection portion and connected to a second connection terminal, and an intermediate portion connected between the first connection portion and the second connection portion and including a planar portion extending along the plate thickness direction; a second step of assembling a packing from the other side in the axial direction to the bus bar in a state where the second connection portion is inserted into the bus bar insertion portion, bringing the other end face in the axial direction of the packing holder into contact with the packing, and bringing one end face in the axial direction of the packing holder into contact with the planar portion; a third step of assembling the bus bar integrated with the packing holder and the packing to a housing provided with an insertion space portion into which the second connection portion of the bus bar is inserted along the axial direction, and temporarily fixing the packing and a large diameter portion of the insertion space portion; and a fourth step of pushing the packing holder toward the other side in the axial direction with respect to the insertion space portion by the planar portion to push the packing into a small diameter portion positioned on the other side in the axial direction of the large diameter portion in the insertion space portion, thereby fully fixing the packing and the small diameter portion.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exemplary perspective view of a terminal block according to an embodiment;

FIG. 2 is an exemplary exploded perspective view of the terminal block according to the embodiment;

FIG. 3 is an exemplary perspective view of a packing of the terminal block according to the embodiment;

FIG. 4 is an exemplary perspective view of a packing holder of the terminal block according to the embodiment;

FIG. 5 is an exemplary sectional view of the terminal block according to the embodiment;

FIG. 6 is an exemplary sectional view of the terminal block according to the embodiment, illustrating a first step;

FIG. 7 is an exemplary sectional view of the terminal block according to the embodiment, illustrating a second step;

FIG. 8 is an exemplary sectional view of the terminal block according to the embodiment, illustrating a third step;

FIG. 9 is an exemplary flowchart of a method for manufacturing a terminal block according to an embodiment;

FIG. 10 is an exemplary sectional view of the terminal block according to a modification;

FIG. 11 is an exemplary perspective view of a bus bar of a terminal block according to a modification;

FIG. 12 is an exemplary perspective view of a packing holder of the terminal block according to the modification;

FIG. 13 is an exemplary sectional view of the terminal block according to the modification, illustrating a first step;

FIG. 14 is an exemplary sectional view of the terminal block according to the modification, illustrating a second step;

FIG. 15 is an exemplary sectional view of the terminal block according to the modification, illustrating a third step; and

FIG. 16 is an exemplary flowchart of a method for manufacturing a terminal block according to a modification.

### DETAILED DESCRIPTION OF THE PREFERRED EMBODIMENTS

Hereinafter, embodiments and modifications according to the present invention will be described in detail with reference to the drawings. Note that the present invention is not limited by the following embodiments and modifications. In addition, constituent elements in the following embodiments and modifications include those that can be easily replaced by those skilled in the art, or those that are substantially the same.

In addition, the embodiments and modifications described below include similar components. Therefore, in the following description, common reference numerals are given to these similar components, and redundant description is omitted. In the present specification, ordinal numbers are used only to distinguish components, members, parts, positions, directions, and the like, and do not indicate order or priority.

### EMBODIMENT

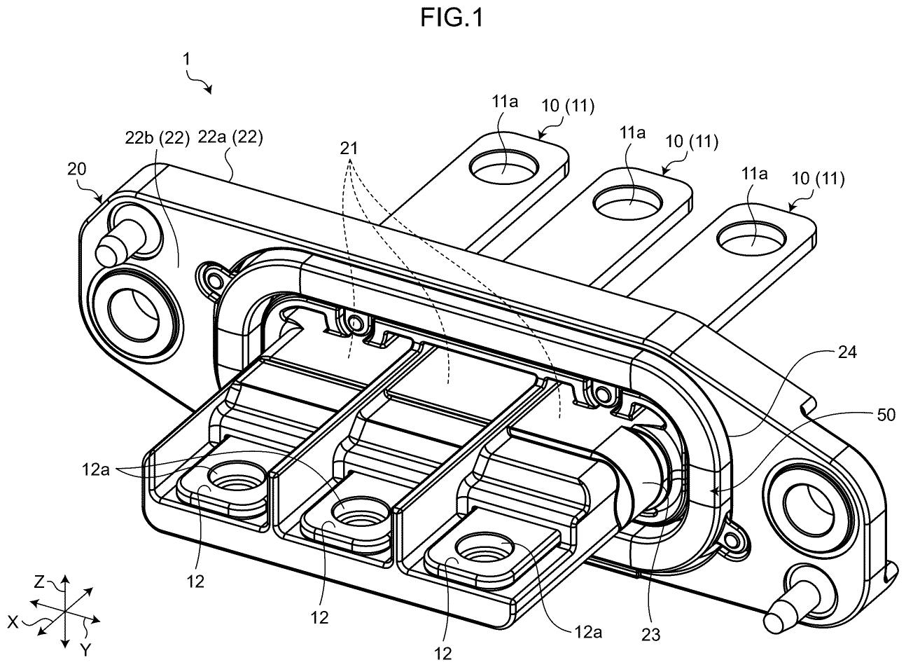

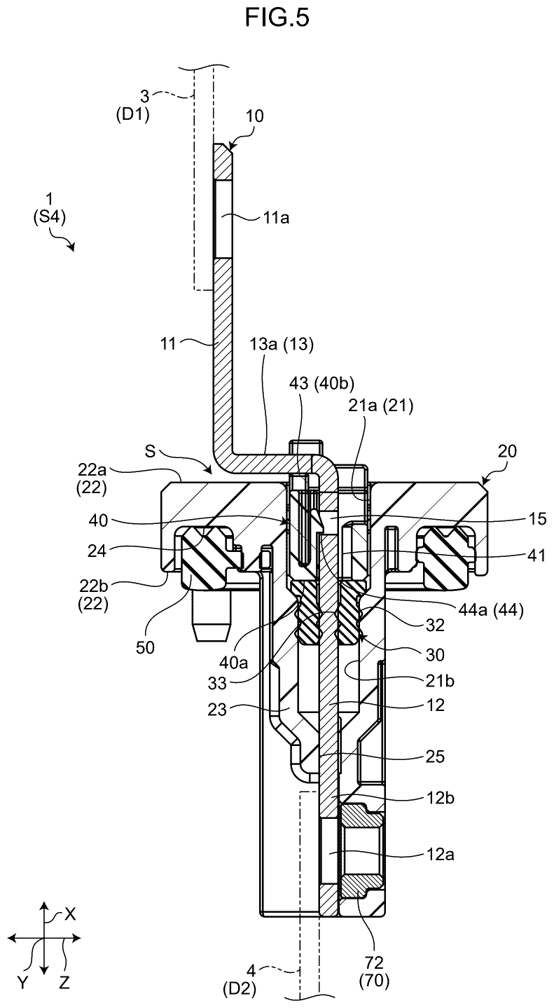

FIG. 1 is a perspective view of a terminal block 1 according to an embodiment. The terminal block 1 of the present embodiment illustrated in FIG. 1 is mounted on a vehicle such as an electric car or a hybrid car, for example, and relays electrical connection between a first device D1 and a second device D2. The terminal block 1 of the present embodiment includes a plurality of bus bars 10, and a first connection terminal 3 (refer to FIG. 5) of the first device D1 is electrically connected to a first connection portion 11 provided at one end portion of the plurality of bus bars 10. In the terminal block 1 of the present embodiment, a second connection terminal 4 of the second device D2 is electrically connected to a second connection portion 12 provided at the other end portion of the plurality of bus bars 10. The first device D1 is, for example, one of a motor and an inverter, and the second device D2 is, for example, the other of the motor and the inverter. Note that the terminal block 1 is not limited to this example, and may be used for, for example, relaying between the first device D1 or the second device D2 and a wiring member, relaying between the wiring member and the wiring member, or the like.

In the following description, among a first direction, a second direction, and a third direction intersecting each other, the first direction is referred to as an “axial direction X”, the second direction is referred to as a “width direction Y”, and the third direction is referred to as a “plate thickness direction Z”. Here, the axial direction X, the width direction Y, and the plate thickness direction Z are substantially orthogonal to each other. Typically, the axial direction X corresponds to an extending direction of the plurality of bus bars 10, an insertion direction of the plurality of bus bars 10 into a housing 20, a depth direction (front-rear direction) of the terminal block 1, or the like. The width direction Y typically corresponds to a width direction of the plurality of bus bars 10, a width direction (left-right direction) of the terminal block 1, or the like. The plate thickness direction Z typically corresponds to a plate thickness direction of the plurality of bus bars 10 (the first connection portion 11 and the second connection portion 12), a fastening direction of the plurality of bus bars 10 and the first connection terminal 3 and the second connection terminal 4, a height direction (vertical direction) of the terminal block 1, or the like. Each direction used in the following description will be described as a direction in a state where the terminal block 1 is assembled to the first connection terminal 3 and the second connection terminal 4 unless otherwise specified.

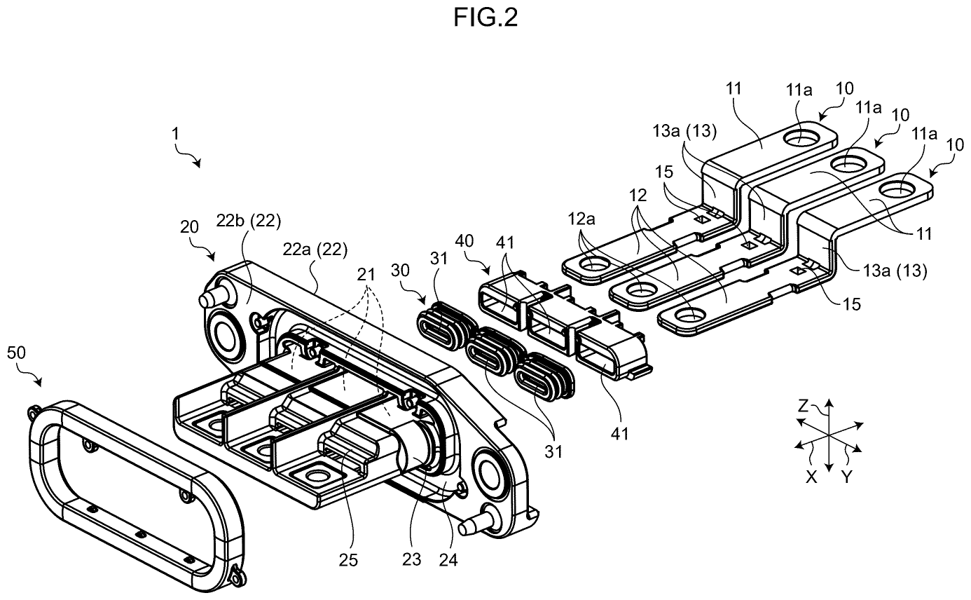

FIG. 2 is an exploded perspective view of the terminal block 1. As illustrated in FIG. 2, the terminal block 1 includes, for example, the plurality of bus bars 10, a housing 20, a packing 30, a packing holder 40, and a seal member 50. The plurality of bus bars 10 are terminal fittings made of a conductive metal material, and are electrically connected to the first connection terminal 3 and the second connection terminal 4 described above. In the present embodiment, the terminal block 1 is provided with three bus bars 10 arranged in the width direction Y. The number of the bus bars 10 is not limited to this example, and for example, one, two, or four or more bus bars 10 may be provided.

The bus bar 10 includes, for example, the first connection portion 11 provided at one end portion in the axial direction X, the second connection portion 12 provided at the other end portion in the axial direction X, and an intermediate portion 13 provided between the first connection portion 11 and the second connection portion 12. The first connection portion 11, the second connection portion 12, and the intermediate portion 13 are integrally formed of a conductive metal material. That is, the bus bar 10 is formed such that each portion is three-dimensionally integrated into a crank shape by performing various processing such as bending processing on one sheet of metal in accordance with the shape corresponding to each portion of the first connection portion 11, the second connection portion 12, and the intermediate portion 13.

The first connection portion 11 is a portion electrically and mechanically connected to the first connection terminal 3. The first connection portion 11 extends along the axial direction X. The first connection portion 11 is provided with an attachment hole 11a to which a fastening member such as a bolt for fastening the bus bar 10 and the first connection terminal 3 is attached. The attachment hole 11a is a through hole penetrating the first connection portion 11 along the plate thickness direction Z, and is configured as, for example, a round hole having a larger diameter than a shaft portion of the bolt.

The second connection portion 12 is a portion electrically and mechanically connected to the second connection terminal 4. The second connection portion 12 extends along the axial direction X and is positioned to be shifted from the first connection portion 11 on the other side in the axial direction X and in the plate thickness direction Z. The second connection portion 12 is provided with an attachment hole 12a to which a fastening member such as a bolt for fastening the bus bar 10 and the second connection terminal 4 is attached. The attachment hole 12a is a through hole penetrating the second connection portion 12 along the plate thickness direction Z, and is configured as, for example, a round hole having substantially the same diameter as the shaft portion of the bolt.

The intermediate portion 13 is a portion connected between the first connection portion 11 and the second connection portion 12. The intermediate portion 13 includes a planar portion 13a extending along the plate thickness direction Z, and forms a step between the first connection portion 11 and the second connection portion 12. The intermediate portion 13 is bent at an angle of 90° with respect to the first connection portion 11 and the second connection portion 12, for example. That is, in the present embodiment, substantially the entire intermediate portion 13 is configured as a planar portion 13a extending along the plate thickness direction Z. The thickness direction of the planar portion 13a is along the axial direction X intersecting the plate thickness direction Z of the first connection portion 11 and the second connection portion.

The housing 20 holds the second connection portions 12 of the three bus bars 10 arranged in the width direction Y, and is formed of an insulating synthetic resin material. The housing 20 is provided with, for example, a housing main body 22 and a housing protrusion 23 protruding from the housing main body 22 to the side opposite to the bus bar 10 along the axial direction X. In the housing 20, the housing main body 22 and the housing protrusion 23 are integrally formed.

An insertion space portion 21 into which the second connection portion 12 of the bus bar 10 is inserted along the axial direction X is provided inside the housing main body 22 and the housing protrusion 23. The insertion space portion 21 penetrates the housing main body 22 and the housing protrusion 23 along the axial direction X. In the present embodiment, the housing 20 is provided with three insertion space portions 21 corresponding to the bus bars 10, and these three insertion space portions 21 are partitioned from each other in the width direction Y.

The housing main body 22 has one end face 22a on one side (bus bar 10 side) in the axial direction X and the other end face 22b on the other side in the axial direction X. The one end face 22a is a portion facing the intermediate portion 13 of the bus bar 10 in the axial direction X in a peripheral edge portion of the insertion space portion 21. The other end face 22b is a portion provided with a recess 24 for holding the seal member 50 in the peripheral edge portion of the housing protrusion 23. The recess 24 is recessed from the other end face 22b toward one side in the axial direction X and opened toward the other side in the axial direction X. The recess 24 is formed in, for example, a substantially elliptical annular shape along the outer shape of the seal member 50.

The seal member 50 suppresses entry of foreign matter such as moisture into the terminal block 1 through an annular gap between the housing 20 and a cylindrical portion (not illustrated) of the second device D2 described above. The seal member 50 is formed of an elastically deformable member such as rubber or resin. The seal member 50 is formed in, for example, a substantially elliptical tubular shape and is fitted into the recess 24 described above. The seal member 50 is interposed between the other end face 22b of the housing main body 22 and an end face of a cylindrical portion (not illustrated) of the second device D2 in a state where the terminal block 1 is connected to the second device D2.

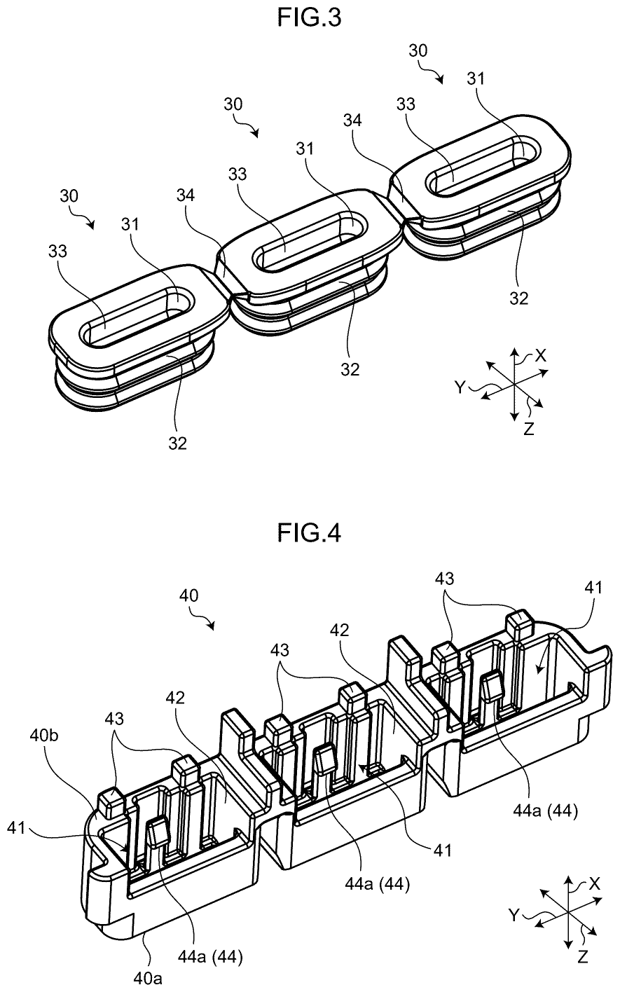

FIG. 3 is a perspective view of the packing 30 of the terminal block 1. As illustrated in FIG. 3, the packing 30 is provided with, for example, an insertion hole 31 through which the second connection portion 12 of the bus bar 10 is inserted along the axial direction X, and seals the periphery of the second connection portion 12 inserted into the insertion hole 31. In the present embodiment, the terminal block 1 is provided with three packings 30 corresponding to the bus bars 10. For example, the three packings 30 are connected to each other via a coupling portion 34 provided between two adjacent packings 30 in the width direction Y. The packing 30 is formed of, for example, an elastically deformable member such as rubber. The packing 30 is also referred to as a terminal packing, a rubber plug, a bush, or the like.

The packing 30 is provided with a plurality of outer peripheral lip portions 32 and a plurality of inner peripheral lip portions 33. The outer peripheral lip portion 32 is a pleated water stop portion formed in a substantially annular shape along the outer peripheral surface of the packing 30. In the present embodiment, the packing 30 is provided with two outer peripheral lip portions 32 arranged side by side in the axial direction X. In a state where the packing 30 is mounted in the insertion space portion 21 (refer to FIG. 5) of the housing 20, the outer peripheral lip portion 32 comes into contact with the inner surface of the insertion space portion 21 and waterproofs between the outer peripheral lip portion and the inner surface. The outer peripheral lip portion 32 is configured to come into close contact with the inner surface of the insertion space portion 21 by elastic deformation and seal the annular space between the inner surface and the outer peripheral surface of the packing 30.

The inner peripheral lip portion 33 is a pleated water stop portion formed in a substantially annular shape along the inner peripheral surface of the packing 30. In the present embodiment, the packing 30 is provided with two inner peripheral lip portions 33 (refer to FIG. 5) arranged side by side in the axial direction X. In a state where the second connection portion 12 of the bus bar 10 is inserted (press-fitted) into the insertion hole 31, the inner peripheral lip portion 33 comes into contact with the outer surface of the second connection portion 12 and waterproofs between the inner peripheral lip portion and the outer surface. The inner peripheral lip portion 33 is configured to come into close contact with the outer surface of the second connection portion 12 by elastic deformation and seal an annular space between the outer surface and the inner peripheral surface of the packing 30.

FIG. 4 is a perspective view of the packing holder 40 of the terminal block 1, and FIG. 5 is a sectional view of the terminal block 1. As illustrated in FIGS. 4 and 5, the packing holder 40 is provided with, for example, a bus bar insertion portion 41 through which the second connection portion 12 of the bus bar 10 is inserted along the axial direction X, supports the periphery of the second connection portion 12 inserted through the bus bar insertion portion 41, and supports the packing 30 in the axial direction X. In the present embodiment, the packing holder 40 is provided with three bus bar insertion portions 41 corresponding to the bus bars 10. The three bus bar insertion portions 41 are partitioned from each other in the width direction Y via a partition wall 42 provided between two bus bar insertion portions 41 adjacent to each other in the width direction Y, for example. The packing holder 40 is formed of, for example, an insulating synthetic resin material.

The packing holder 40 is provided with, for example, a protrusion 43 partially provided on one end face 40b in the axial direction X. In the present embodiment, in the packing holder 40, two protrusions 43 are provided at intervals in the width direction Y with respect to the plurality of bus bar insertion portions 41. The protrusion 43 protrudes from the packing holder 40 toward one side in the axial direction X and supports the planar portion 13a (refer to FIG. 5) of the bus bar 10. That is, the protrusion 43 supports the planar portion 13a in a state of being separated from the one end face 40b of the packing holder 40. In the present embodiment, in a state where the packing holder 40 is assembled to the insertion space portion 21, gaps S are provided between the planar portion 13a and the one end face 40b of the packing holder 40 and between the planar portion 13a and the one end face 22a of the housing 20.

The packing holder 40 is provided with the other end face 40a in the axial direction X facing the packing 30. The other end face 40a is a portion that supports the packing 30 in the axial direction X. In the present embodiment, the packing holder 40 is inserted into the insertion space portion 21 in a state where the second connection portion 12 is inserted into the bus bar insertion portion 41, the one end face 40b is in contact with the planar portion 13a and the other end face 40a is in contact with the packing 30. The packing holder 40 functions as a portion that pushes the packing 30 toward the other side in the axial direction X (the back side of the insertion space portion 21) at the time of assembly to the insertion space portion 21.

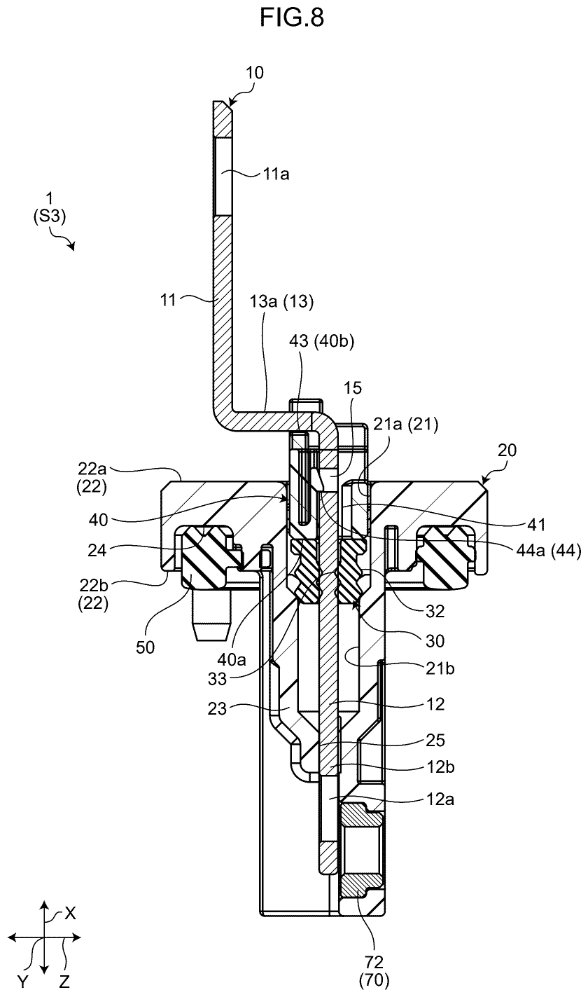

Here, in the present embodiment, the insertion space portion 21 includes a large diameter portion 21a to which the packing 30 is temporarily fixed and a small diameter portion 21b to which the packing 30 is fully fixed. The large diameter portion 21a is a portion positioned on one side of the insertion space portion 21 in the axial direction X, and is open to one end face 22a of the housing 20. The large diameter portion 21a has an opening width larger in diameter than the packing 30, and the packing 30 is temporarily fixed in a free state (refer to FIG. 8). The small diameter portion 21b is a portion of the insertion space portion 21 positioned on the other side of the large diameter portion 21a in the axial direction X, and communicates with the large diameter portion 21a along the axial direction X. The small diameter portion 21b has an opening width smaller in diameter than the packing 30, and is press-fitted (fitted) in a state where the packing 30 is elastically compressed, and the packing 30 is fully fixed.

In the present embodiment, the housing 20 is provided with the press-fitting portion 25 to which a distal end portion 12b on the other side of the second connection portion 12 in the axial direction X is press-fitted. The press-fitting portion 25 is provided at the distal end portion of the housing protrusion 23 described above in the housing 20. The press-fitting portion 25 is positioned on the other side of the small diameter portion 21b in the axial direction X and communicates with the insertion space portion 21 along the axial direction. The press-fitting portion 25 has an opening width smaller in diameter than the small diameter portion 21b, and the distal end portion 12b of the second connection portion 12 is press-fitted and fixed along the axial direction X. That is, the opening width of the press-fitting portion 25 along the plate thickness direction Z is configured to be substantially the same as or slightly smaller than the opening width of the second connection portion 12 along the plate thickness direction Z.

The packing holder 40 is provided with a lock portion 44 that locks the second connection portion 12 along the axial direction X. The lock portion 44 protrudes in a claw shape from the packing holder 40 along the plate thickness direction Z. The lock portion 44 has a locking surface 44a facing the edge portion of an opening portion 15 provided in the second connection portion 12 in the axial direction X, and the movement of the packing holder 40 in the axial direction X with respect to the second connection portion 12 is restricted by locking the locking surface 44a and the edge portion of the opening portion 15. For example, the lock portion 44 is provided at an intermediate position between the two protrusions 43 (refer to FIG. 4) in each bus bar insertion portion 41 of the packing holder 40.

As illustrated in FIG. 5, in the present embodiment, for example, when the terminal block 1 is assembled to the first connection terminal 3 and the second connection terminal 4, first, the second connection portion 12 of the bus bar 10 and the second connection terminal 4 of the second device D2 are fastened and fixed by a fastening member 70. The fastening member 70 includes, for example, a bolt (not illustrated) and a nut 72, and the nut 72 is attached and fixed to the distal end portion of the housing protrusion 23 in advance. The bolt is provided with a shaft portion having an outer peripheral surface provided with a male screw portion that meshes with a female screw portion of the nut 72, and a head portion having a larger diameter than the shaft portion. In a state where the second connection terminal 4 and the second connection portion 12 are sandwiched between the head portion and the nut 72, the shaft portion of the bolt penetrates the second connection terminal 4 and the second connection portion 12 in the plate thickness direction Z and is fastened to the nut 72.

Next, the first connection portion 11 of the bus bar 10 and the first connection terminal 3 of the first device D1 are fastened and fixed by a fastening member. Similarly to the fastening member 70 described above, the fastening member includes a bolt and a nut. In a state where the first connection terminal 3 and the first connection portion 11 are sandwiched between the head portion and the nut, the shaft portion of the bolt penetrates the first connection terminal 3 and the first connection portion 11 in the plate thickness direction Z and is fastened to the nut. Accordingly, the terminal block 1 is assembled to the first connection terminal 3 and the second connection terminal 4.

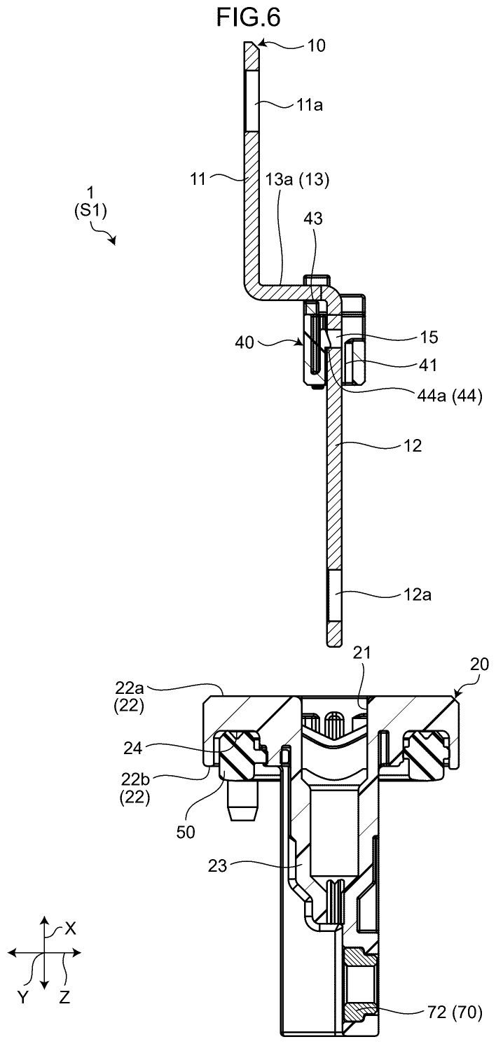

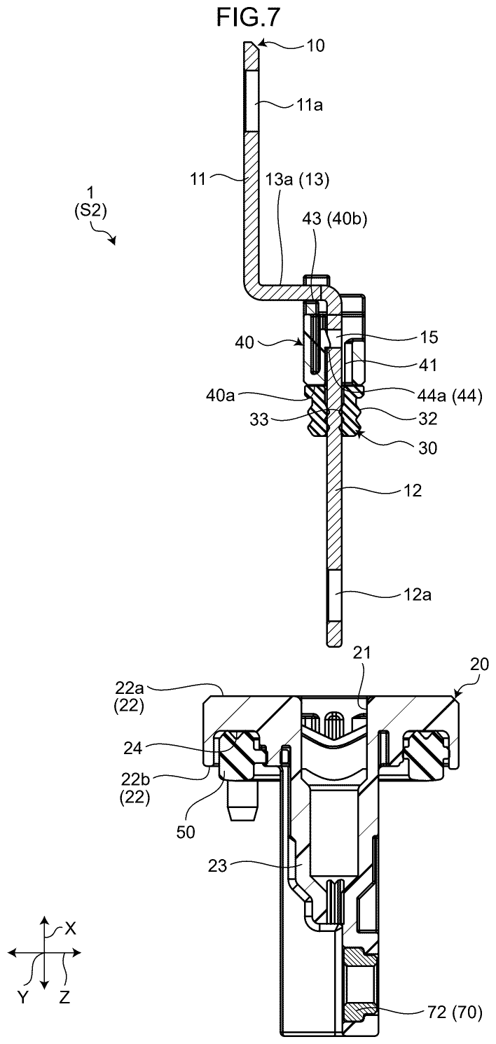

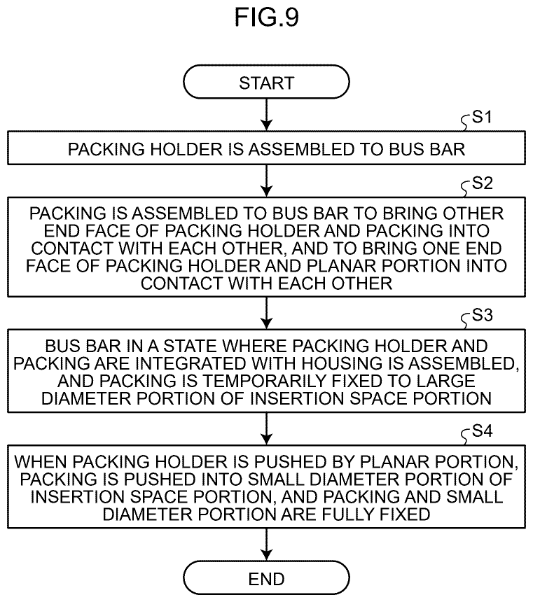

Next, an example of a method for manufacturing the terminal block 1 having the above configuration will be described. FIG. 6 is a sectional view of the terminal block 1 and illustrates a first step S1, FIG. 7 is a sectional view of the terminal block 1 and illustrates a second step S2, and FIG. 8 is a sectional view of the terminal block 1 and illustrates a third step S3. FIG. 9 is a flowchart of a method for manufacturing the terminal block 1.

First, in the process of the first step S1, as illustrated in FIGS. 6 and 9, the packing holder 40 is assembled to the bus bar 10. In this case, the bus bar insertion portion 41 of the packing holder 40 is assembled to the second connection portion 12 of the bus bar 10 so as to be inserted along the axial direction X from the other side in the axial direction X. Then, the lock portion 44 of the packing holder 40 is locked to the opening portion 15 of the second connection portion 12, and the second connection portion 12 and the packing holder 40 are integrated (fixed).

Next, in the process of the second step S2, as illustrated in FIGS. 7 and 9, the packing 30 is further assembled to the bus bar 10. In this case, the second connection portion 12 of the bus bar 10 to which the packing holder 40 is attached is assembled such that the insertion hole 31 of the packing 30 is inserted along the axial direction X from the other side in the axial direction X. Then, the other end face 40a of the packing holder 40 in the axial direction X and the packing 30 are brought into contact with each other, and the one end face 40b of the packing holder 40 in the axial direction X and the planar portion 13a of the bus bar 10 are brought into contact with each other.

Next, in the process of the third step S3, as illustrated in FIGS. 8 and 9, the bus bar 10 in a state where the packing holder 40 and the packing 30 are integrated with the housing 20 is assembled. In this case, the distal end portion 12b of the second connection portion 12 is assembled to the insertion space portion 21 of the housing 20 so as to be inserted along the axial direction X from one side in the axial direction X. Then, the distal end portion 12b of the second connection portion 12 is press-fitted into the press-fitting portion 25 of the housing 20, and the packing 30 is temporarily fixed to the large diameter portion 21a of the insertion space portion 21.

Then, in the process of the fourth step S4, as illustrated in FIGS. 5 and 9, the packing holder 40 is pushed into the other side in the axial direction X with respect to the insertion space portion 21 by the planar portion 13a. In this case, for example, when an operator grips the first connection portion 11 of the bus bar 10 and pushes down the packing holder 40, the packing 30 is pushed into the small diameter portion 21b of the insertion space portion 21, and the packing 30 and the small diameter portion 21b can be fully fixed. Through the first step S1 to the fourth step S4, the bus bar 10, the packing 30, and the packing holder 40 can be assembled to the housing 20 to manufacture the terminal block 1.

As described above, in the terminal block 1 and the method for manufacturing the terminal block 1 according to the present embodiment, the packing holder 40 is inserted into the insertion space portion 21 of the housing 20 in a state where the second connection portion 12 of the bus bar 10 is inserted into the bus bar insertion portion 41, the other end face 40a in the axial direction X is in contact with the packing 30 and the one end face 40b in the axial direction X is in contact with the planar portion 13a of the bus bar 10. With this configuration, in the terminal block 1 and the method for manufacturing the terminal block 1, for example, by pushing the packing holder 40 toward the other side in the axial direction X by the planar portion 13a, the packing holder 40 can be pushed down and at the same time, the packing 30 can also be pushed to a predetermined position in the insertion space portion 21. As a result, the terminal block 1 and the method for manufacturing the terminal block 1 can improve the assemblability with respect to the housing 20.

Further, in the terminal block 1 of the present embodiment, the insertion space portion 21 includes the large diameter portion 21a to which the packing 30 is temporarily fixed and the small diameter portion 21b which is positioned on the other side of the large diameter portion 21a in the axial direction X and to which the packing 30 is fully fixed, and at least when the packing 30 is inserted into the small diameter portion 21b, the packing holder 40 has the other end face 40a in contact with the packing 30 and one end face 40b in contact with the planar portion 13a. With this configuration, in the terminal block 1, for example, when the packing 30 is inserted into the small diameter portion 21b from the large diameter portion 21a of the packing 30, by pushing the packing holder 40 toward the other side in the axial direction X by the planar portion 13a, the packing 30 can be pushed into the small diameter portion 21b of the insertion space portion 21 through the packing holder 40. As a result, the terminal block 1 can be further improved in the assemblability with respect to the housing 20.

Further, in the terminal block 1 of the present embodiment, the housing 20 has the press-fitting portion 25 which communicates with the insertion space portion 21 along the axial direction X and to which the distal end portion 12b of the second connection portion 12 on the other side in the axial direction X is press-fitted. With this configuration, in the terminal block 1, for example, the distal end portion 12b of the bus bar 10 can be press-fitted and fixed to the housing 20 by the press-fitting portion 25, and furthermore, the movement (removal) of the bus bar 10, the packing 30, and the packing holder 40 to one side in the axial direction X with respect to the housing 20 can be suppressed.

In the terminal block 1 of the present embodiment, the packing holder 40 has the lock portion 44 that protrudes along the plate thickness direction Z and locks the second connection portion 12 along the axial direction X. With this configuration, in the terminal block 1, for example, the movement of the packing holder 40 in the axial direction X with respect to the second connection portion 12 can be restricted by the lock portion 44, and hence the assemblability of the packing holder 40 with respect to the bus bar 10 can be improved.

Further, in the terminal block 1 of the present embodiment, the packing holder 40 is provided with the protrusion 43 that is partially provided on the one end face 40b and is in contact with the planar portion 13a. With this configuration, in the terminal block 1, for example, a gap S in the axial direction X can be secured between the planar portion 13a and the one end face 40b of the packing holder 40 and between the planar portion 13a and the one end face 22a of the housing 20 by the protrusion 43, and the packing 30 can be more reliably pushed into the small diameter portion 21b of the insertion space portion 21.

### Modified Example

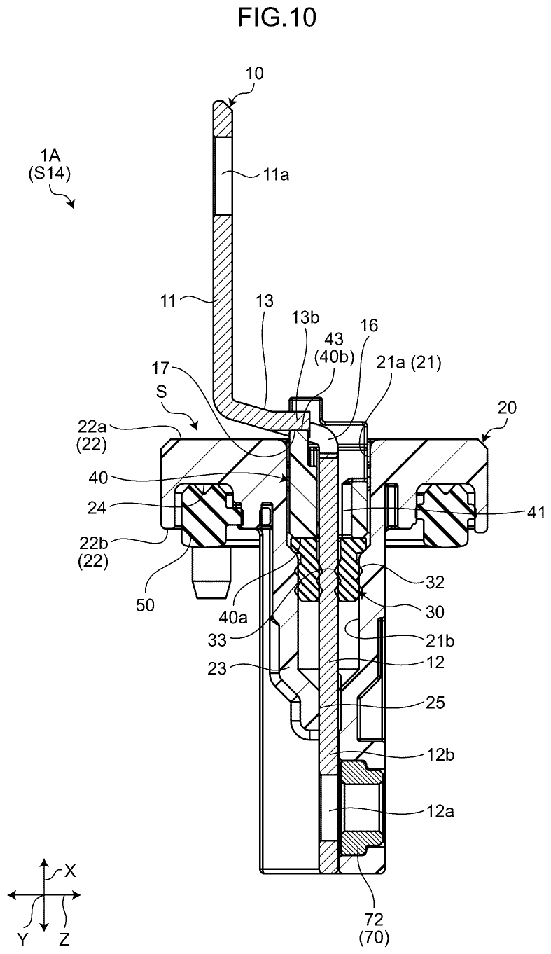

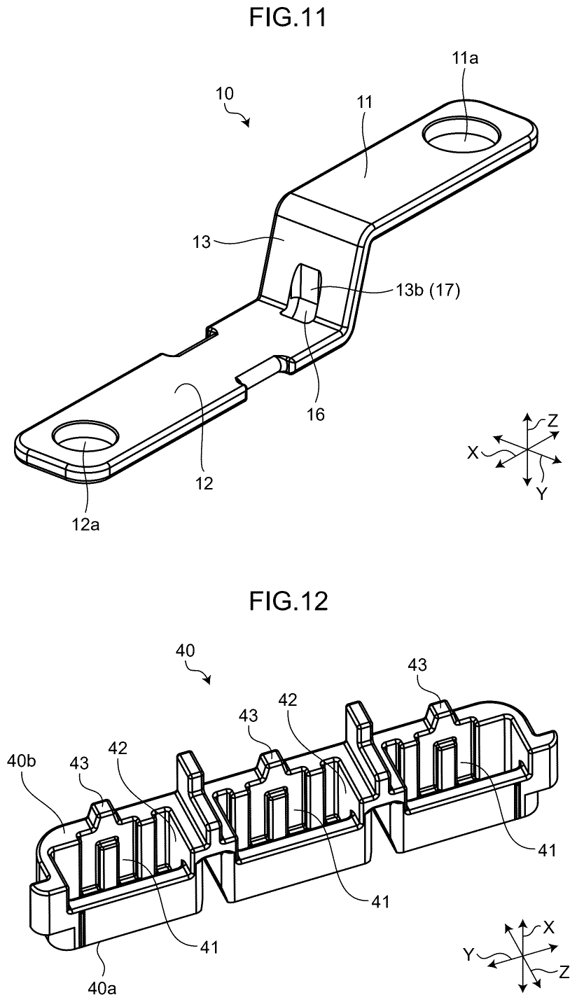

FIG. 10 is a sectional view of a terminal block 1A according to a modification, FIG. 11 is a perspective view of a bus bar 10 of the terminal block 1A, and FIG. 12 is a perspective view of a packing holder 40 of the terminal block 1A. The terminal block 1A illustrated in FIGS. 10 to 12 has the same configuration as the terminal block 1 of the above embodiment. Therefore, the terminal block 1A can obtain functions and effects similar to those of the above embodiment based on the similar configuration.

However, as illustrated in FIGS. 10 to 12, the present modification is different from the above embodiment in that a planar portion 13b is partially provided in the intermediate portion 13 of the bus bar 10. Specifically, in the present modification, the intermediate portion 13 is bent at an angle of approximately 45° with respect to the first connection portion 11 and the second connection portion 12, for example. That is, in the present modification, the intermediate portion 13 is inclined (intersecting) with respect to the plate thickness direction Z. In the present modification, the intermediate portion 13 is provided with a recess 17 recessed toward one side in the axial direction X, and a planar portion 13b is provided at the bottom of the recess 17. The planar portion 13b extends along the plate thickness direction Z.

As illustrated in FIG. 11, the recess 17 is partially recessed at the central portion of the intermediate portion 13 in the width direction Y. In the present modification, the opening width of the recess 17 along the width direction Y is substantially the same as the width of the protrusion 43 (refer to FIG. 12) of the packing holder 40 along the width direction Y. That is, in the present modification, the recess 17 functions as a portion with which the protrusion 43 of the packing holder 40 is engaged. In the present modification, the packing holder 40 is provided at the central portion in the width direction Y so as to correspond to the recess 17 with respect to the plurality of bus bar insertion portions 41. In the present modification, the packing holder 40 is not provided with the above-described lock portion 44 (refer to FIG. 4) locked to the second connection portion 12. The bus bar 10 is provided with a through hole 16 adjacent to the recess 17.

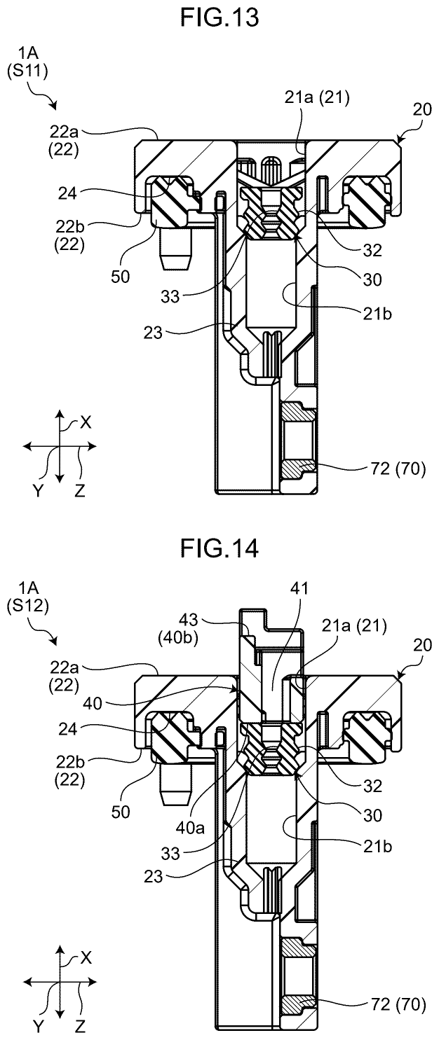

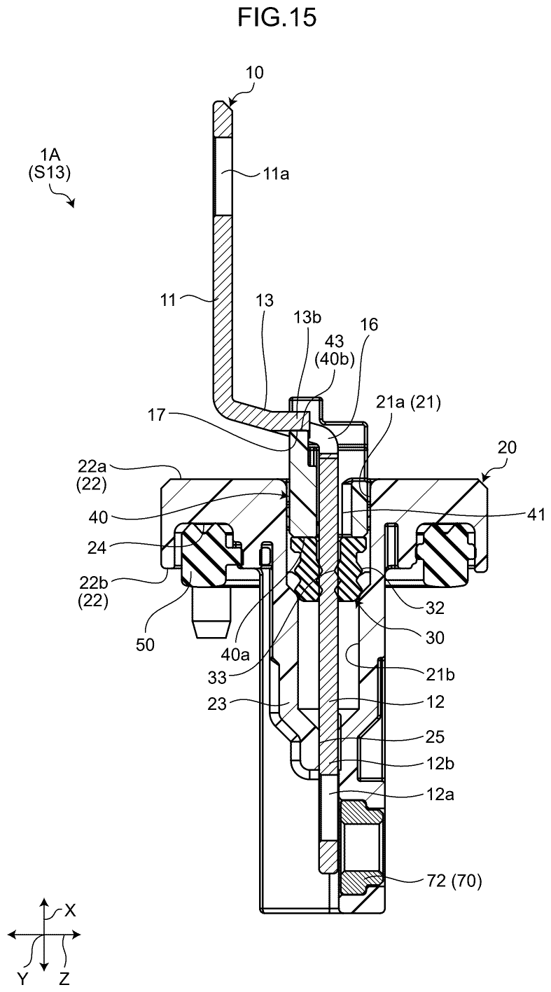

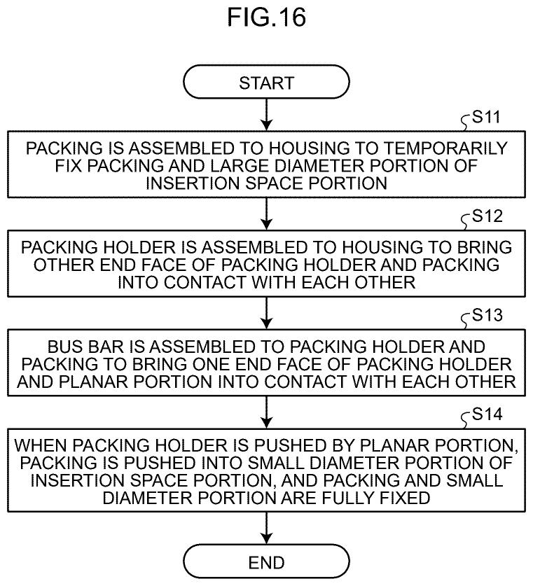

Next, an example of a method for manufacturing the terminal block 1A having the above configuration will be described. FIG. 13 is a sectional view of the terminal block 1A and illustrates a first step S11, FIG. 14 is a sectional view of the terminal block 1A and illustrates a second step S12, and FIG. 15 is a sectional view of the terminal block 1A and illustrates a third step S13. FIG. 16 is a flowchart of a method for manufacturing the terminal block 1A.

First, in the process of the first step S11, as illustrated in FIGS. 13 and 16, the packing 30 is assembled to the housing 20. In this case, the packing 30 is inserted into the insertion space portion 21 of the housing 20 from one side in the axial direction X to temporarily fix the packing 30 and the large diameter portion 21a of the insertion space portion 21.

Next, in the process of the second step S12, as illustrated in FIGS. 14 and 16, the packing holder 40 is further assembled to the housing 20. In this case, the packing holder 40 is inserted into the large diameter portion 21a of the insertion space portion 21 in a state where the packing 30 is attached from one side in the axial direction X. Then, the other end face 40a of the packing holder 40 in the axial direction X is brought into contact with the packing 30.

Next, in the process of the third step S13, as illustrated in FIGS. 15 and 16, the bus bar 10 is assembled to the packing holder 40 and the packing 30. In this case, the bus bar insertion portion 41 of the packing holder 40 and the insertion hole 31 of the packing 30 are assembled such that the second connection portion 12 of the bus bar 10 is inserted along the axial direction X from one side in the axial direction X. Then, the distal end portion 12b of the second connection portion 12 is press-fitted into the press-fitting portion 25 of the housing 20, and the protrusion 43 of the packing holder 40 is engaged with the recess 17 of the intermediate portion 13 to bring the one end face 40b and the planar portion 13b into contact with each other.

Then, in the process of the fourth step S4, as illustrated in FIGS. 10 and 16, the packing holder 40 is pushed into the other side in the axial direction X with respect to the insertion space portion 21 by the planar portion 13b. In this case, for example, when an operator grips the first connection portion 11 of the bus bar 10 and pushes down the packing holder 40, the packing 30 is pushed into the small diameter portion 21b of the insertion space portion 21, and the packing 30 and the small diameter portion 21b can be fully fixed. Through the first step S11 to the fourth step S14, the bus bar 10, the packing 30, and the packing holder 40 can be assembled to the housing 20 to manufacture the terminal block 1A.

As described above, also by the terminal block 1A and the method for manufacturing the terminal block 1A of the present modification, for example, by pushing the packing holder 40 toward the other side in the axial direction X by the planar portion 13b, the packing holder 40 can be pushed down, and at the same time, the packing 30 can also be pushed into the small diameter portion 21b of the insertion space portion 21. As a result, the terminal block 1A and the method for manufacturing the terminal block 1A can improve the assemblability with respect to the housing 20.

Further, in the terminal block 1A of the present modification, the intermediate portion 13 has the recess 17 engaged with the protrusion 43, and the planar portion 13b is provided at the bottom of the recess 17. With this configuration, in the terminal block 1A, for example, the movement of the packing holder 40 with respect to the bus bar 10 can be restricted by the engagement between the protrusion 43 and the recess 17, and hence the assemblability of the packing holder 40 with respect to the bus bar 10 can be improved. In addition, for example, the engagement between the protrusion 43 and the recess 17 allows the packing 30 to be more reliably easily pushed into the small diameter portion 21b of the insertion space portion 21 via the packing holder 40.

In the above embodiment and the above modification, a case where the insertion space portion 21 includes the large diameter portion 21a to which the packing 30 is temporarily fixed and the small diameter portion 21b to which the packing 30 is permanently fixed has been exemplified. However, the present invention is not limited to this example, and for example, the insertion space portion may include only the small diameter portion 21b to which the packing 30 is fully fixed. In the above embodiment and the above modified example, the case where the protrusion 43 of the packing holder 40 and the planar portions 13a and 13b in contact with each other has been exemplified, but the present invention is not limited to this example. For example, the protrusion 43 may not be provided, and the one end face 40b and the planar portions 13a and 13b may be provided in a state of being in contact with each other.

Although the embodiment and the modification of the present invention have been exemplified above, the embodiment and the modification are merely examples, and are not intended to limit the scope of the invention. The above-described embodiments and modifications can be implemented in various other forms, and various omissions, substitutions, combinations, and changes can be made without departing from the gist of the invention. In addition, specifications (structure, type, direction, form, size, length, width, thickness, height, number, arrangement, position, material, and the like) of each configuration, shape, and the like can be appropriately changed and implemented.

In the terminal block and the method for manufacturing a terminal block according to the present embodiment, the packing holder is inserted into the insertion space portion of the housing in a state where the second connection portion is inserted into the bus bar insertion portion, the other end face in the axial direction is in contact with the packing and one end face in the axial direction is in contact with a planar portion of the bus bar. With this configuration, in the terminal block and the method for manufacturing a terminal block, for example, by pushing the packing holder toward the other side in the axial direction by the planar portion, the packing holder can be pushed down and at the same time, the packing can also be pushed to a predetermined position in the insertion space portion. As a result, the terminal block and the method for manufacturing a terminal block have an effect that the assemblability with respect to the housing can be improved.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A terminal block comprising:
a bus bar including a first connection portion extending along an axial direction and connected to a first connection terminal, a second connection portion extending along the axial direction and positioned to be shifted in a plate thickness direction intersecting the axial direction and the axial direction with respect to the first connection portion and connected to a second connection terminal, and an intermediate portion connected between the first connection portion and the second connection portion and including a planar portion extending along the plate thickness direction;
a housing provided with an insertion space portion into which the second connection portion of the bus bar is inserted along the axial direction;
a packing that is inserted into the insertion space portion together with the second connection portion and seals an annular space between an outer surface of the second connection portion and an inner surface of the insertion space portion; and
a packing holder provided with a bus bar insertion portion through which the second connection portion is inserted along the axial direction, the packing holder being inserted into the insertion space portion in a state where the second connection portion is inserted into the bus bar insertion portion, and the other end face in the axial direction is in contact with the packing and one end face in the axial direction is in contact with the planar portion.

2. The terminal block according to claim 1, wherein
the insertion space portion includes a large diameter portion to which the packing is temporarily fixed and a small diameter portion which is positioned on the other side of the large diameter portion in the axial direction and to which the packing is fully fixed, and
the packing holder has the other end face in contact with the packing and the one end face in contact with the planar portion at least when the packing is inserted into the small diameter portion.

3. The terminal block according to claim 1, wherein
the housing includes a press-fitting portion communicating with the insertion space portion along the axial direction and into which a distal end portion of the second connection portion on the other side in the axial direction is press-fitted.

4. The terminal block according to claim 2, wherein
the housing includes a press-fitting portion communicating with the insertion space portion along the axial direction and into which a distal end portion of the second connection portion on the other side in the axial direction is press-fitted.

5. The terminal block according to claim 1, wherein
the packing holder includes a lock portion that protrudes along the plate thickness direction and locks the second connection portion along the axial direction.

6. The terminal block according to claim 2, wherein
the packing holder includes a lock portion that protrudes along the plate thickness direction and locks the second connection portion along the axial direction.

7. The terminal block according to claim 1, wherein
the packing holder includes a protrusion partially provided on the one end face and is in contact with the planar portion.

8. The terminal block according to claim 2, wherein
the packing holder includes a protrusion partially provided on the one end face and is in contact with the planar portion.

9. The terminal block according to claim 7, wherein
the intermediate portion includes a recess engaged with the protrusion, and
the planar portion is provided at a bottom portion of the recess.

10. The terminal block according to claim 8, wherein
the intermediate portion includes a recess engaged with the protrusion, and
the planar portion is provided at a bottom portion of the recess.

11. A method for manufacturing a terminal block, the method comprising:
a first step of assembling a packing holder including a bus bar insertion portion into which a second connection portion is inserted along an axial direction, with respect to a bus bar including a first connection portion extending along the axial direction and connected to a first connection terminal, the second connection portion extending along the axial direction and positioned to be shifted in a plate thickness direction intersecting the axial direction and the axial direction with respect to the first connection portion and connected to a second connection terminal, and an intermediate portion connected between the first connection portion and the second connection portion and including a planar portion extending along the plate thickness direction;
a second step of assembling a packing from the other side in the axial direction to the bus bar in a state where the second connection portion is inserted into the bus bar insertion portion, bringing the other end face in the axial direction of the packing holder into contact with the packing, and bringing one end face in the axial direction of the packing holder into contact with the planar portion;
a third step of assembling the bus bar integrated with the packing holder and the packing to a housing provided with an insertion space portion into which the second connection portion of the bus bar is inserted along the axial direction, and temporarily fixing the packing and a large diameter portion of the insertion space portion; and
a fourth step of pushing the packing holder toward the other side in the axial direction with respect to the insertion space portion by the planar portion to push the packing into a small diameter portion positioned on the other side in the axial direction of the large diameter portion in the insertion space portion, thereby fully fixing the packing and the small diameter portion.

12. A method for manufacturing a terminal block, the method comprising:
a first step of assembling a packing from one side in an axial direction to a housing provided with an insertion space portion into which a second connection portion is inserted along the axial direction in a bus bar including a first connection portion extending along the axial direction and connected to a first connection terminal, the second connection portion extending along the axial direction and positioned to be shifted in a plate thickness direction intersecting the axial direction and the axial direction with respect to the first connection portion and connected to a second connection terminal, and an intermediate portion connected between the first connection portion and the second connection portion and including a planar portion extending along the plate thickness direction, and temporarily fixing the packing and a large diameter portion of the insertion space portion;
a second step of assembling a packing holder including a bus bar insertion portion through which the second connection portion is inserted along the axial direction to the insertion space portion of the housing, and bringing the other end face of the packing holder in the axial direction into contact with the packing;
a third step of assembling the packing and the packing holder such that the second connection portion of the bus bar is inserted through the bus bar insertion portion along the axial direction, and bringing one end face of the packing holder in the axial direction and the planar portion into contact with each other; and
a fourth step of pushing the packing holder toward the other side in the axial direction with respect to the insertion space portion by the planar portion to push the packing into a small diameter portion positioned on the other side in the axial direction of the large diameter portion in the insertion space portion, thereby fully fixing the packing and the small diameter portion.
